(19) United States
(12) Patent Application Publication
(10) Pub. No.: US 2010/0327209 A1
(43) Pub. Date: Dec. 30, 2010

(54) HYDRAULIC MEDIUM INSERT FOR A CONTROL VALVE IN A HYDRAULIC ACTUATOR

(75) Inventors: Jens Hoppe, Erlangen (DE); Stefan Konias, Erlangen (DE)

Correspondence Address: LUCAS & MERCANTI, LLP, 475 Park Avenue South, New York, NY, 10016, US

(73) Assignee: SCHAEFFLER TECHNOLOGIES GMBH & CO. KG, Herzogenaurach (DE)

(21) Appl. No.: 12/864,299

(22) PCT Filed: Jan. 24, 2009
(86) PCT No.: PCT/EP2009/000446

§ 371 Date: Jul. 23, 2010

(30) Foreign Application Priority Data
Jan. 26, 2008 (DE) 10 2008 006 178.6

(51) Int. Cl. F16K 27/00

(52) U.S. Cl. 251/366

(57) ABSTRACT

A hydraulic medium insert for a control valve in a hydraulic actuator which has a tubular guide sleeve for guiding a control piston, which is disposed in a receptacle, which has passage openings for the hydraulic medium, which are disposed in the guide sleeve and separated by webs. A plastic part is disposed on the exterior side of the guide sleeve and has sealing webs, which are supported on the inside on the webs of the guide sleeve, which separate the passage openings, and press against the inside of the receptacle to form a seal on the outside.

### FIELD OF THE INVENTION

The invention relates to a hydraulic medium conducting insert for a control valve in a hydraulic actuating device, having a tubular guide sleeve for guiding a control piston, which guide sleeve is disposed in a receptacle.

DE 10 2005 052 481 A1 has disclosed a hydraulic medium conducting insert of the type in question for a control valve, for example, said insert being produced from round stock by means of a shaping process that involves machining. The dimensions of the blank to be machined are determined by the outside dimensions of the hydraulic medium conducting insert, and a considerable amount of material has to be removed to form the passage openings. The disadvantages with this prior art are the poor degree of utilization of material and the high costs associated with machining.

It is an object of the invention to provide a hydraulic medium conducting insert which is advantageous as regards the costs of materials and production.

The invention is achieved through the features of claim 1, and further advantageous embodiments and developments can be found in the subclaims.

According to the invention, the proposal is that a plastic part is disposed on the exterior side of the guide sleeve, said plastic part having sealing webs, which are supported on the inside on the webs of the guide sleeve, which separate the passage openings, and on the outside rest against the inside of the receptacle to form a seal.

A control valve generally comprises a hydraulic portion and an actuator. The hydraulic portion has a valve housing and a control piston, which is disposed therein and can be moved by the actuator. In these cases, the term “hydraulic medium conducting insert” refers to the valve housing of the hydraulic portion. In these cases, the receptacle is, for example, formed on a rotor of the hydraulic actuating device or on a cylinder head or cylinder head cover in which the hydraulic portion can be accommodated, the valve housing resting against the boundary surface of the receptacle to form a seal.

In an alternative embodiment of a control valve, an intermediate sleeve is inserted between the valve housing and the control piston in order, for example, to obtain more complex flow paths for the hydraulic medium. In these cases, the intermediate sleeve can also be regarded as a hydraulic medium conducting insert, which is accommodated in the receptacle formed by the valve housing.

This enumeration is not exhaustive: other embodiments of control valves, in which the invention can be implemented, are also conceivable.

The solution according to the invention provides a hydraulic medium conducting insert which comprises a guide sleeve, which can be produced from a very thin-walled blank, preferably a tube, and a plastic part, which can be produced at low cost by an injection molding method. The plastic part of the hydraulic medium conducting insert seals the latter in the receptacle and prevents hydraulic medium unintentionally passing from one hydraulic medium conduit into an adjacent hydraulic medium conduit. The degree of utilization of material for the hydraulic medium conducting insert is thus considerably improved since a large part of the wall thickness of the hydraulic medium conducting insert is now formed by the low-cost plastic part which can be produced by an injection molding method. Moreover, it is possible to use a tube for the guide sleeve, and with this tube only the passage openings have to be bored, thus reducing the required machining for the component to a minimum overall.

The hydraulic medium conducting insert may have an integrated filter fabric, thus making it possible to eliminate any further filter elements. A very large filter surface disposed directly at the control edges is thereby created. Moreover, this eliminates any additional effort involved in installing the filter elements.

It is furthermore proposed that the guide sleeve and the plastic part are connected to one another by way of positive engagement in the longitudinal direction of the guide sleeve, thus preventing both parts from moving relative to one another in the longitudinal direction.

Moreover, annular grooves may be provided on the exterior side of the guide sleeve, in the region of the passage openings, ensuring optimum oil flow.

The plastic part may preferably be formed by an overmolding on the guide sleeve, this being a particularly low-cost method of production. Insofar as the passage openings are disposed in the lower lying annular grooves proposed, it is appropriate to support the sliding tools for the overmolding process on the webs, which are at a higher level, thus ensuring that the lower lying annular grooves with the passage openings disposed therein cannot come into contact with the overmolding material during the injection process. The filter fabric proposed can be disposed on the guide sleeve before the overmolding process, thus ensuring that said fabric is fixed between the guide sleeve and the plastic part after the overmolding of said sleeve.

If the plastic part is produced as a separate component, the proposal is that it should be secured on the guide sleeve by means of a latching, press-fitting and/or adhesively bonded joint. The filter fabric proposed is then included in the overmolding process during the production of the plastic part, making the filter fabric itself a component part of the plastic part.

It is furthermore proposed that the guide sleeve has a connection piece at one end, said connection piece having an axial bore for the entry of hydraulic medium and/or for the connection of an actuator. This makes it possible to adopt the low cost solution of using a tube for the guide sleeve, it being possible to produce the considerably more massive connection piece separately. Overall, this further reduces the required proportion of machining since the dimensions of the blank forming the guide sleeve are no longer codetermined by the connection piece.

The connection piece may be connected positively to the plastic part, with the result that the connection piece is connected to the guide sleeve by way of the plastic part, which is held on the guide sleeve.

A particularly simple way of connecting all three parts consists in connecting the connection piece and the plastic part to one another in such a way that the guide sleeve is held between the two parts.

The invention is explained in greater detail below with reference to a preferred exemplary embodiment. In the drawings, the following is shown in particular:

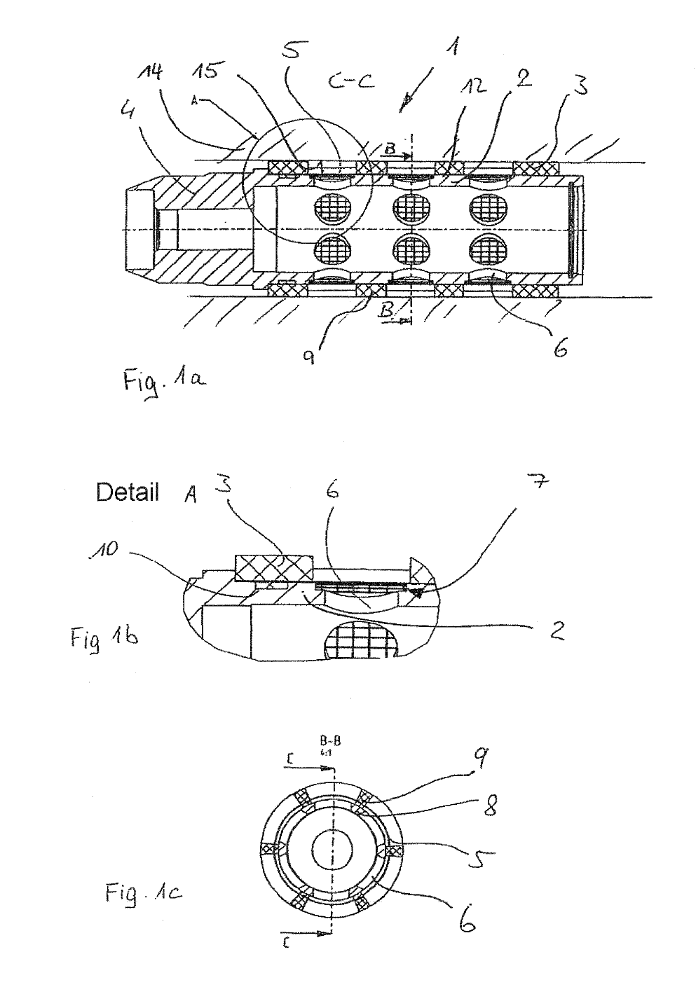

FIGS. 1a-1c: a hydraulic medium conducting insert with a guide tube produced by machining and overmolded sealing webs;

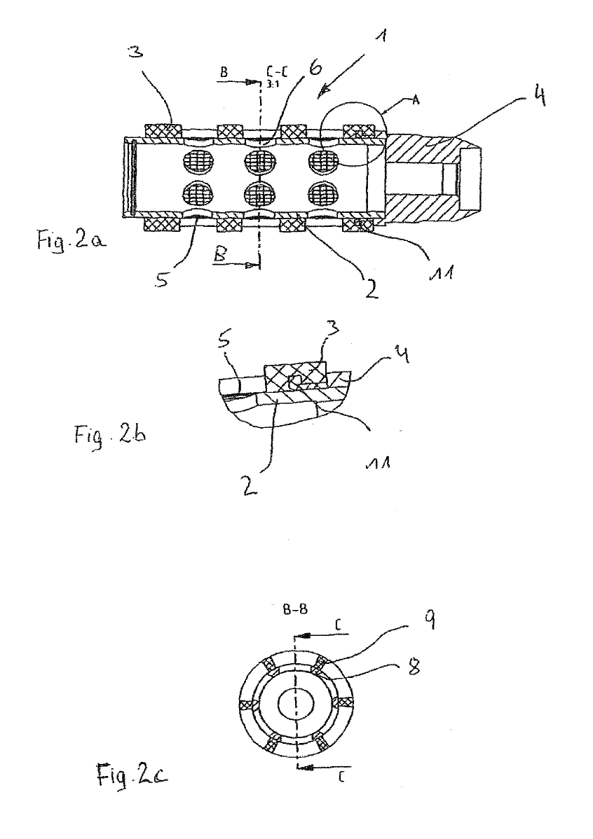

FIGS. 2a-2c: a hydraulic medium conducting insert with a guide tube, a separate connection piece and overmolded sealing webs;

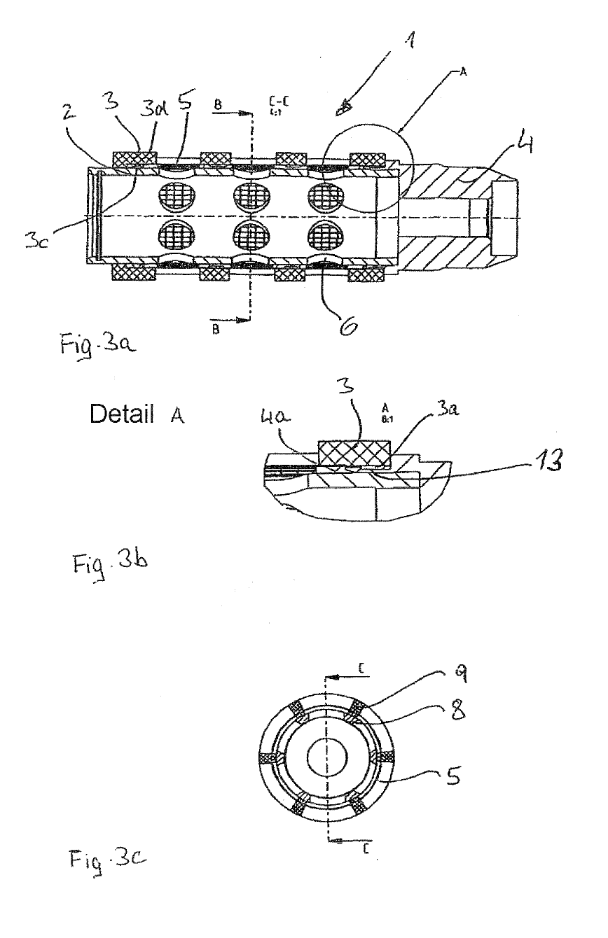

FIGS. 3a-3c: a hydraulic medium conducting insert with a guide tube, a separate connection piece and a fit-on plastic part secured at one end by way of positive engagement;

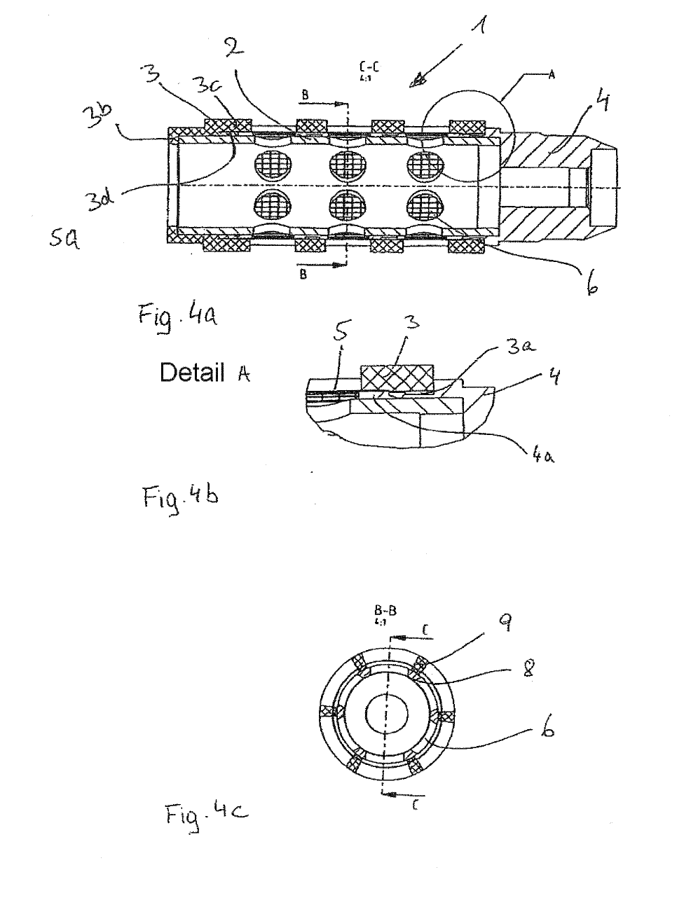

FIGS. 4a-4c: a hydraulic medium conducting insert with a guide tube, a separate connection piece and a fit-on plastic part secured at both ends by way of positive engagement;

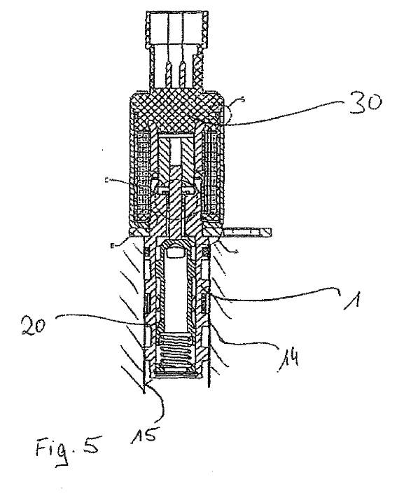

FIG. 5: a hydraulic medium conducting insert with an actuator and a control piston.

FIG. 5 shows a hydraulic medium conducting insert 1, which is of hollow construction and has a control piston 20, which is guided on the inside and is connected to an actuator 30. The hydraulic medium conducting insert 1 itself is disposed in a control valve 14 for a device for the variable adjustment of the timing of gas exchange valves of an internal combustion engine, as described in DE 10 2005 052 481 A1, for example. The adjustment of the timing is accomplished through the movement of the control piston 20 in the hydraulic medium conducting insert 1 and the flow of hydraulic medium controlled in this way. As regards the operation of the hydraulic medium conducting insert and its arrangement in the control valve, express reference is made to DE 10 2005 052 481 A1, which is thereby incorporated into the disclosure of this application. The hydraulic medium conducting insert 1 designed in accordance with the invention and shown in FIGS. 1a-1c has a three-part basic structure with a guide sleeve 2, a connection piece 4 associated with the actuator 30, and an overmolded plastic part 3. The guide sleeve 2 serves to guide the control piston 20 and is provided with passage openings 6 which can be closed by the latter. The overmolded plastic part 3 serves to seal the hydraulic medium conducting insert 1 in the receptacle thereof, and to ensure that the hydraulic medium conduits are sealed with respect to one another. By virtue of the design in accordance with the invention of the hydraulic medium conducting insert 1, all that remains to be done is to machine the thin-walled guide sleeve 2, while the considerably thicker wall thickness required for the seal is formed by the plastic part 3. Overall, the proportion of machining that is required has thereby been considerably reduced, as is clearly apparent from the drawing. Disposed between the plastic part 3 and the guide sleeve 2 there is furthermore a filter 5 in the form of a hose, which is disposed on the guide sleeve 2 before said guide sleeve is overmolded and, as a result, ideally covers all the passage openings 6 after overmolding. The passage openings 6 are disposed in the manner of a grid, comprising three rows, each having 6 openings. Owing to the regular arrangement of the passage openings 6, rectilinear webs 8 are formed between the passage openings, and the sealing webs 9 of the plastic part 3 are supported radially on the inside thereon. Arranging the sealing webs 9 of the plastic part 3 on the webs 8 of the guide sleeve 2 provides adequate support for the sealing webs 9, enabling said webs to satisfactorily perform their proper function, namely to seal the hydraulic medium conduits with respect to one another at the inner wall of the receptacle 15. Provided in the exterior wall of the guide sleeve 2 is a groove 10, into which plastic material can flow during overmolding, resulting in positive engagement between the plastic part 3 and the guide sleeve 2 once the plastic has solidified, and ensuring that the plastic part 3 cannot slip in the longitudinal direction of the guide sleeve 2. The passage openings 6 are disposed in annular grooves 7, resulting between the passage openings 6 in a shoulder 12, on which the sliding tool can be supported during overmolding, clamping the filter 5 securely in the process. FIGS. 2a-2c show an alternative embodiment of the invention, in which the connection piece 4 and the guide sleeve 2 is formed by two separate parts. This further increases the degree of utilization of the material since this makes it possible to use a tube for the guide sleeve 2, in which all that is necessary is to bore the passage openings 6. The considerably more massive connection piece can then be produced as a separate component, in a process involving machining, for example.

A retaining element 11 with a radially outward-projecting hook is furthermore provided, being overmolded by the plastic part 3 and securing the plastic part 3 in the longitudinal direction. The retaining element 11 can be of one-piece construction with the connection piece 4 or, alternatively, can be designed as a separate clamping ring on the guide sleeve 2. FIGS. 3a-3c show another alternative embodiment, in which the plastic part 3 together with an overmolded filter 5 are secured as a prefabricated part on the guide sleeve 2. The filter 5 is overmolded on both sides by interior layers 3c and exterior layers 3d of the plastic part 3, with the result that there is no contact between the filter 5 and the guide sleeve 2. The connection piece 4 has a cylindrical extension 4a, in which a groove 14 is provided. The plastic part 3 projects beyond the extension 4a and latches into the groove 14 by means of an inward-projecting shoulder 3a. The plastic part 3 is thus connected to the connection piece 4 in the longitudinal direction by means of positive engagement. FIGS. 4a-4c show the embodiment from FIGS. 3a-3c, the plastic part 3 additionally being provided here with an inward-projecting shoulder 3b on its end remote from the connection piece 4. After the plastic part 3 has been latched to the connection piece 4, the guide sleeve 2 is thus clamped between the shoulder 3b and the connection piece 4, thus allowing all three individual components to be joined together in a pre-assembly process and then installed jointly as a composite component.

In addition, a further filter portion 5a may be provided, extending radially between the shoulder 3b. This filter portion 5a covers the axial opening of the guide sleeve 2. It would thus also be conceivable to have the hydraulic medium supplied via this axial opening.

1. A hydraulic medium conducting insert for a control valve in a hydraulic actuating device, comprising:
a tubular guide sleeve for guiding a control piston, which guide sleeve is disposed in a receptacle, having passage openings for a hydraulic medium, which are disposed in the guide sleeve and separated by webs,
wherein a plastic part is disposed on an exterior side of the guide sleeve, the plastic part having sealing webs, which are supported on an inside on webs of the guide sleeve, which separate the passage openings, and on the outside rest against an inside of the receptacle to form a seal.

2. The hydraulic medium conducting insert of claim 1, wherein the hydraulic medium conducting insert has an integrated filter fabric.

3. The hydraulic medium conducting insert of claim 1, wherein the guide sleeve and the plastic part are connected to one another by way of positive engagement in a longitudinal direction of the guide sleeve.

4. The hydraulic medium conducting insert of claim 1, wherein the passage openings are disposed in annular grooves provided on the exterior side of the guide sleeve.

5. The hydraulic medium conducting insert of claim 1, wherein the plastic part is formed by an overmolding.

6. The hydraulic medium conducting insert of claim 1, wherein the plastic part can be secured on the guide sleeve by means of a latching joint.

7. The hydraulic medium conducting insert of claim 1, wherein the plastic part is secured on the guide sleeve by means of a press-fitting and/or adhesively bonded joint.

8. The hydraulic medium conducting insert of claim 1, wherein the guide sleeve has a connection piece at one end, and the connection piece has an axial bore for entry of hydraulic medium and/or for connection of an actuator.

9. The hydraulic medium conducting insert of claim 7, wherein the connection piece is connected positively to the plastic part.

10. The hydraulic medium conducting insert of claim 8, wherein the connection piece and the plastic part are connected to one another in such a way that the guide sleeve is held between the connection piece and the plastic part.
